(19) United States
(12) Patent Application Publication
(10) Pub. No.: US 2011/0061429 A1
(43) Pub. Date: Mar. 17, 2011

(54) CAR BURGLAR PROOF ASSEMBLY WITH THE FUNCTIONS OF POSITIONING AND FIXEDNESS

(76) Inventor: Yu-Hsien Wu, Kaoshiung (TW)

(21) Appl. No.: 12/562,125

(22) Filed: Sep. 17, 2009

(51) Int. Cl. B60R 25/00

(52) U.S. Cl. 70/237

(57) ABSTRACT

A car burglar proof assembly with the functions of positioning and fixedness comprises an outer tube; the outer tube being installed with a core barrel; a telescopic inner tube; the inner tube can be telescopically inserted into the outer tube and being formed with a plurality of lock holes; a lock structure installed in the core barrel of the outer tube; the lock structure including a lock core, a buckle, a spring and a positioning unit; a lower side of the lock core being installed with the buckle; a lower side of the buckle being installed with the positioning unit which can be positioned into the lock hole of the inner tube; the spring being installed between the buckle and the positioning unit; and center of the positioning unit being formed with a penetrating hole for passing through a cylinder of the buckle.

### FIELD OF THE INVENTION

The present invention relates to car locks, and particularly to a car burglar proof assembly with the functions of positioning and fixedness which can adjust the length of a car lock.

### BACKGROUND OF THE INVENTION

Generally a telescopically car burglar proof lock, such as a tire lock, a steering wheel lock, etc., includes an outer tube and an inner tube which is telescopically moved within the outer tube. A lock core in the outer tube serves to control the fixedness and telescopic movement of the inner tube. However at this prior art design, it is possible that the inner tube will leave from the outer tube because no mechanism is designed for preventing the inner tube from moving out of the outer tube.

Therefore, a positioning ball is added to the outer tube for preventing the inner tube to move out of the outer tube. However this will cause that the outer tube must have a lock means for control the movement of the inner tube and some other positioning mechanism for controlling the positioning ball is necessary to be used. All these designs have increase the cost and works needed.

Thereby there is an eager demand for a novel design which has both the function of retaining and locking.

### SUMMARY OF THE INVENTION

Accordingly, the object of the present invention is to provide a car burglar proof assembly with the functions of positioning and fixedness which can adjust the length of a car lock.

To achieve above object, the present invention provides a car burglar proof assembly with the functions of positioning and fixedness which comprises an outer tube; the outer tube being installed with a core barrel; a telescopic inner tube; the inner tube can be telescopically inserted into the outer tube and being formed with a plurality of lock holes; a lock structure installed in the core barrel of the outer tube; the lock structure including a lock core, a buckle, a spring and a positioning unit; a lower side of the lock core being installed with the buckle; a lower side of the buckle being installed with the positioning unit which can be positioned into the lock hole of the inner tube; the spring being installed between the buckle and the positioning unit; and center of the positioning unit being formed with a penetrating hole for passing through a cylinder of the buckle.

The various objects and advantages of the present invention will be more readily understood from the following detailed description when read in conjunction with the appended drawing.

### BRIEF DESCRIPTION OF THE DRAWINGS

FIG. 1 is an assembled schematic view of the present invention.

FIG. 2 is an assembled cross sectional view of the present invention.

FIG. 3 is a schematic view showing that when the inner tube telescopically moves, the positioning unit is reduced inwards.

FIG. 4 is a schematic view showing the locking state of the present invention.

FIG. 5 shows the positioning unit of the present invention.

FIG. 6 is an elevational view of FIG. 5.

FIG. 7 is an upper view of the present invention.

FIG. 8 is a cross sectional view along line 8-8 of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

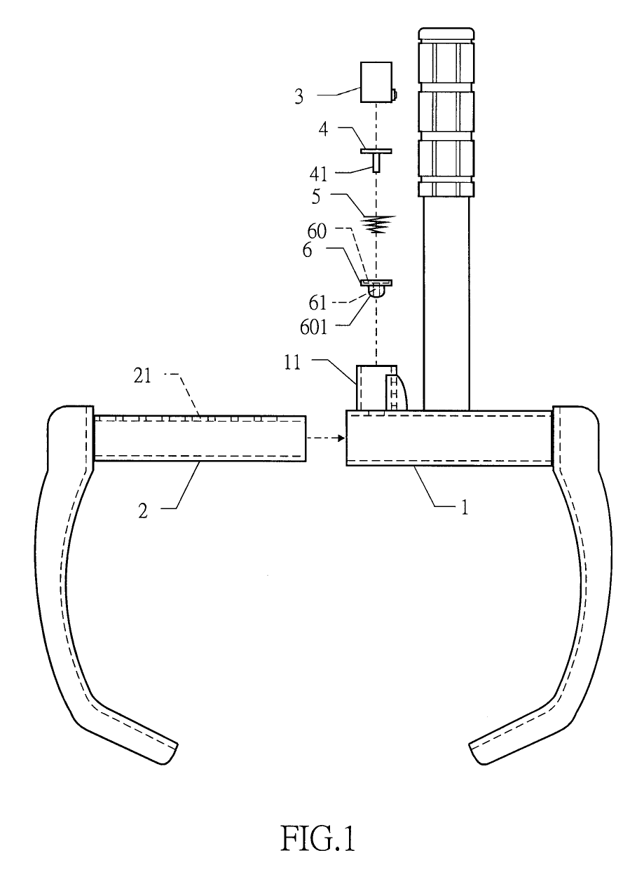

Referring to FIG. 1, the car burglar proof assembly with the functions of positioning and fixedness of the present invention is illustrated. As illustrated in the drawing, the present invention is suitable for a telescopic car burglar proof look, such as tire locks, steering wheel locks, etc. Herein, a tire lock is used as an example. However this is not used to confine the scope of the present invention, the present invention is suitable for any telescopic car lock.

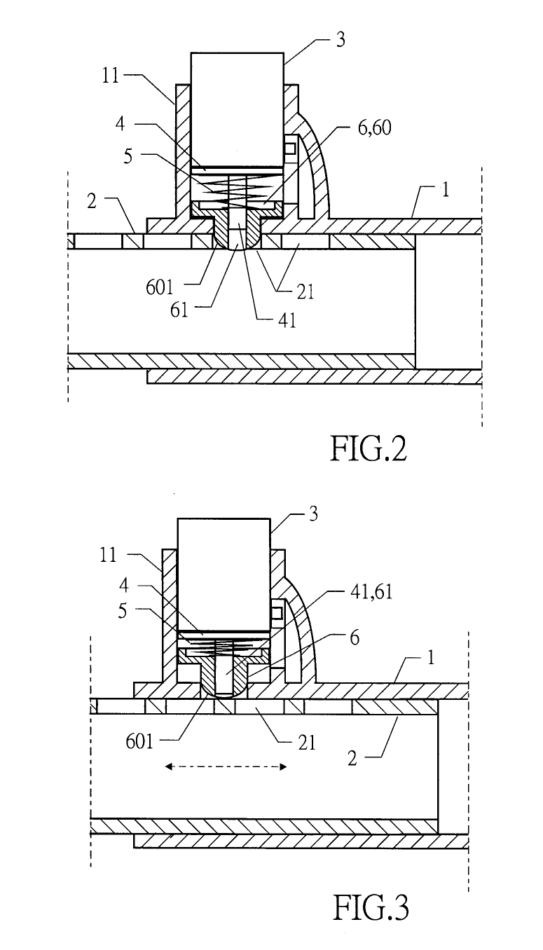

With referring to FIGS. 1 and 2, the present invention includes an outer tube 1 and a telescopic inner tube 2. The outer tube 1 is installed with a core barrel 11 for receiving other elements. A lock structure includes a lock core 3, a buckle 4, a spring 5 and a positioning unit 6. The inner tube 2 can be telescopically inserted into the outer tube 1 and is formed with a plurality of lock holes 21.

Referring to FIG. 1, the lock core 3 is a prior art press type lock core. A lower side of the lock core 3 is formed with the buckle 4. A lower side of the buckle 4 is installed with the positioning unit 6 which can be positioned into the lock hole 21 of the inner tube 2. A spring 5 is installed between the buckle 4 and the positioning unit 6. A center of the positioning unit 6 is installed with a penetrating hole 61 for passing through a cylinder 41 of the buckle 4.

An upper side of the buckle 4 is a plate body. A lower center of the plate body is extended with a cylinder 41. An outer diameter of the cylinder 41 is smaller than or equal to an inner diameter of the penetrating hole 61 of the positioning unit 6.

Referring to FIGS. 5 to 8, an upper side of the positioning unit 6 is formed with a concave space 60 for receiving the spring 5. A lower side of the positioning unit 6 is formed with an approximate semi-spherical protrusion 601.

With referring to FIGS. 2 and 3, when the lock core 3 is not pressed to be in lock state, the inner tube 2 can telescopically move within the outer tube 1 as desired for adjusting a length of a car burglar proof lock. When the inner tube 2 telescopically moves, the positioning unit 6 in the positioning unit 6 moves through the lock holes 21 of the inner tube 2 to generate a resistance force.

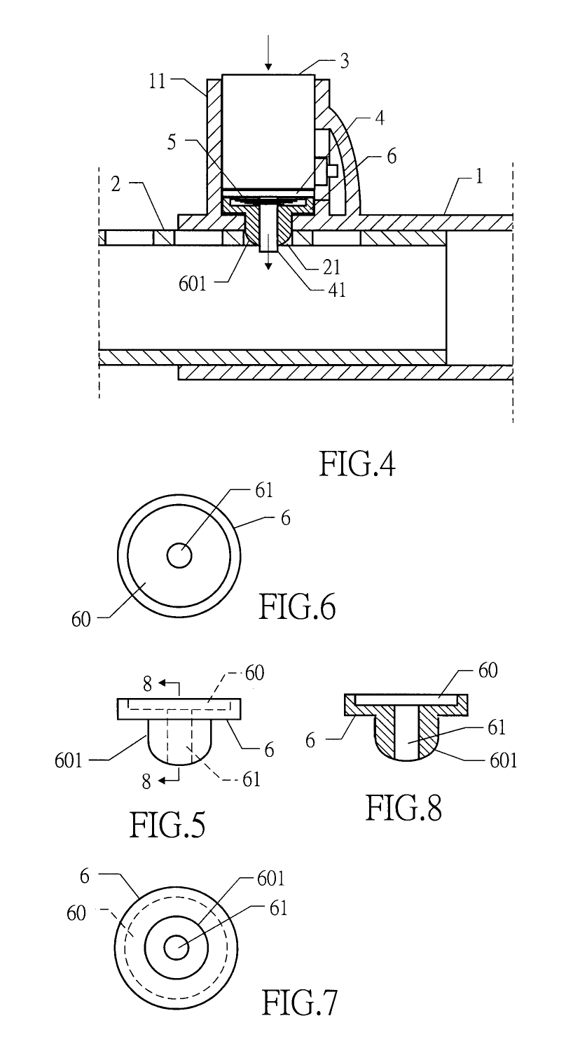

With referring to FIG. 4, when the lock core 3 is locked, the, buckle 4 descends due to the pressure from the lock core 3 so that the lock core 3, buckle 4 and positioning unit 6 are tightly overlapped. The spring 5 between the buckle 4 and the positioning unit 6 is compressed to be hidden into the concave space 60 of the positioning unit 6. Meanwhile, the cylinder 41 of the buckle 4 protrudes out of the positioning unit 6 from the penetrating hole 61 of the positioning unit 6 so that the lock hole 21 of the inner tube 2 is penetrated through by the positioning unit 6 and the cylinder 41 of the buckle 4. Thus the inner tube 2 is fixed to the outer tube 1.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A car burglar proof assembly with the functions of positioning and fixedness comprising:
an outer tube; the outer tube being installed with a core barrel;
a telescopic inner tube; the inner tube can be telescopically inserted into the outer tube and being formed with a plurality of lock holes;
a lock structure installed in the core barrel of the outer tube; the lock structure including a lock core, a buckle, a spring and a positioning unit; a lower side of the lock core being installed with the buckle; a lower side of the buckle being installed with the positioning unit which can be positioned into the lock hole of the inner tube; the spring being installed between the buckle and the positioning unit; and center of the positioning unit being formed with a penetrating hole for passing through a cylinder of the buckle.

2. The car burglar proof assembly with the functions of positioning and fixedness as claimed in claim 1, wherein a lower center of the plate body is extended with a cylinder; an outer diameter of the cylinder is smaller than or equal to an inner diameter of the penetrating hole of the positioning unit.

3. The car burglar proof assembly with the functions of positioning and fixedness as claimed in claim 1, wherein an upper side of the positioning unit is formed with a concave space for receiving the spring; and a lower side of the positioning unit is formed with an approximate semi-spherical protrusion.
